(19) United States
(12) Patent Application Publication
(10) Pub. No.: US 2004/0066521 A1
(43) Pub. Date: Apr. 8, 2004

(54) System and method for measuring drive belt tension

(76) Inventor: Michael Thomas Swab, Acworth, GA (US)

Correspondence Address: PHILIPS INTELLECTUAL PROPERTY & STANDARDS, P.O. BOX 3001, BRIARCLIFF MANOR, NY, 10510, US

(21) Appl. No.: 10/264,085

(22) Filed: Oct. 3, 2002

(51) Int. Cl. G01B 11/14

(52) U.S. Cl. 356/614

(57) ABSTRACT

The present invention provides a non-contact drive belt tension monitoring apparatus for measuring drive belt tension on a drive belt vibrating in response to a stimulus. A coherent light source, associated with the drive belt, generates coherent light which is reflected by a determined region of the drive as reflected coherent light. A light receiver receives reflected coherent light containing vibration information. Attached circuitry processes the output of the light receiver to generate a drive belt tension measurement.

### TECHNICAL FIELD OF THE INVENTION

The invention relates to equipment and methods for measuring belt tension. More specifically, the present invention provides a system and method of measuring belt tension for equipment employed to mount electrical components on printed circuit boards that illuminates a resonating belt with a laser beam.

### BACKGROUND OF THE INVENTION

Automated printed circuit board assembly equipment must accurately place components on printed circuit boards. To do this, an empty printed circuit board or card is typically selected from a storage location and inspected by an assembly machine to check the physical features on the board. Certain of these physical features, called fiducials, are provided to precisely register the parts to be installed on the board. Other such physical features on the circuit board are solder paste contact pads. If the inspected board is not rejected, the assembly machine places the printed circuit board precisely into position to receive components for mounting. The assembly machine then picks each component to be mounted out of storage and inspects the component. If the component is not rejected, the assembly machine then precisely steers the placement of the component with proper registration to its exact mounting position on the printed circuit board.

These assembly machines typically rely on belts to accurately position the boards and electrical components. This is accomplished by tracking the motion of individual belts or components within the assembly equipment (dead reckoning). If a belt is too loose, the belt can slip resulting in random placement of both the circuit board and the electrical components. If the belt is too tight, the bearings associated with the pulleys on which the belts turn can burn out or the belt can tear. Thus, operators must track the belt tension of the various internal belts to ensure proper operation.

One standard method of measuring belt tension is illustrated in FIG. 1A. Here, belt 10 wraps around multiple pulleys 12. If belt 10 is too loose, then belt 10 will slip. However, too much tension on belt 10 places undue stresses on bearings 14 within pulleys 12. Alternatively, too much tension may result in the belt snapping.

Accurate measurement and tracking of belt tension in such assembly equipment is key to ensuring the proper positioning or steering of the mounting equipment, placement of components on their proper circuit board, and the long life of the assembly equipment.

The application of these electric components to printed circuit board requires a high degree of accuracy. In some cases, this requirement is on the order of tens of microns. When these belts are too loose, the mounting device coupled to the belt results in an inaccurate or scattered component placement. If the belts are too tight, the heads will actually be splayed and experience an offset. Therefore, accurate belt tension is extremely important, especially in tools involving small belts wherein the belts are located in confined areas.

One existing solution, as shown in FIG. 1A, uses ultrasonic measurements to determine the tension of the belt. The belt under tension resonates or is plucked like a guitar string to create a measurable oscillation or vibration. FIG. 1B provides an illustration of one device that operates as described in FIG. 1A. A second way of measuring belt tension, as shown in FIG. 1C, involves applying a force 16 to belt 10 wherein deflection 18 of belt 10 is measured. This deflection can be used to determine the tension on belt 10.

The former method involving measurement of vibrations provides a more accurate measure of the tension associated with the belt. However, equipment associated with this method is too large to pluck and measure vibrations associated with small belts located in an areas having close tolerances.

Measurements in confined spaces are often impossible to collect with existing frequency meters specifically designed to measure belt tension. In existing devices, a “C” shaped transducer 19, as shown in FIGS. 1A and 1B, placed around the belt, measures the vibration within the belt when the belt is plucked or resonates. This device requires ample room around the belt in order to properly place transducer 16.

The later deflection method, illustrated in FIG. 1B, requires that a measurement device actually contact belt 10 to determine the force 16 necessary to achieve a prescribed deflection 18 of belt 10 and hence the tension on the belt. This method also requires ample room around the belt to insert the force measurement tool and contact the belt. Additionally, this method requires that the belt in question not be in motion. The repeatability of this measurement depends on the operator of the tool taking their measurements in the same belt location and in the same manner each time. Therefore, a need exists to develop a non-contact system capable of passively measuring belt tension in confined spaces on operating equipment.

### SUMMARY OF THE INVENTION

The present invention provides a system and method of measuring belt tension that substantially eliminates or reduces disadvantages and problems associated with previously developed systems and methods.

The present invention provides a non-contact drive belt tension monitoring apparatus for measuring drive belt tension on a drive belt vibrating in response to a stimulus. A coherent light source, associated with the drive belt, generates coherent light which is reflected by a determined region of the drive as reflected coherent light. A light receiver receives reflected coherent light containing vibration information. Attached circuitry processes the output of the light receiver to generate a drive belt tension measurement.

Another embodiment of the present invention provides a system and method that measures the tension on a drive belt, cable, or line with a laser beam as the beam of coherent light. The laser strikes a resonating belt, cable or line. In turn, the belt, cable or line scatters the laser light to produce modulated light representative of the oscillations of the belt, cable or line under tension. An optical detector collects scattered modulated light in order to measure the frequency of the oscillations. This frequency can be used to quickly determine the tension on the belt, cable or line.

The present invention provides significant advantages over prior art systems. For example, the present invention may act passively with respect to an already resonating drive belt in operating equipment. In this case the belt need not be plucked, as with the ultrasonic transducer, or contacted as in the deflection method. Additionally, the present invention allows measurements to be taken on extremely small drive belts with limited access. This limited access may be required by the design constraints of the device to which the belts are attached. The present invention also only requires access to one surface of the belt. Furthermore, the present invention allows users to take measurements on operating belts, increasing the available time of the equipment.

Since the present invention uses a beam of coherent light directed only to the surface of the drive belt, the affects of ambient noise are greatly reduced. The present invention provides a significant advantage over prior art systems, which use broad spectrum light to illuminate the belt under tension. Such prior systems receive light scattered by all components and machinery proximate to the belt. The use of the laser allows an operator to very accurately collect light scattered by the belt only, wherein the scattered light contains information representative of the vibrations at one precise location on the belt.

Another embodiment of the present invention uses an on-board amplification module coupled to the detector and processor to generate a voltage representative of the frequency of the vibrations or oscillations. This allows operators to merely measure the output voltage with a standard multi-meter and convert that voltage reading into a frequency with a conversion table. Thus, operators can quickly reference or cross-reference the measured voltage to a given frequency of an oscillation within a belt. This combination eliminates the need for a specialized device to further process the output signal.

In yet another embodiment, a feedback system adjusts the tension on the belt to achieve a desired measured frequency of vibrations. This may be accomplished by adjusting the tension applied from the pulleys or endpoints of the belt, cable, or line. This allows the belt, cable and line to be tuned to a desired frequency and tension. It is conceivable that this may be used to maintain a pre-determined amount of stress or tension on the line for various reasons as is known to those skilled in the art. For example, one could use this method to tune musical instruments.

The present invention also allows operators to measure belt tension where the tension must be maintained at a constant level. Such a need arises within assembly equipment used to place electrical components on printed circuit boards. Measurements collected at the beginning of each shift or repeatedly throughout the shift (even on a component by component basis), track the performance of the mounting tool and the life span of the belt, cable, or line. An alarm or error condition may be generated when the drive belt slips with respect to the pulleys. This enables operators and engineers to quickly identify and replace defective belts prior to a failure which causes scratch material or material requiring re-work.

The present invention provides another advantage in that the use of a laser allows the operator to not only access belts that are inaccessible but to access belts from a greater distance than previously possible. In such a case, as long as the belt resonates, the laser need merely be scattered by the resonating belt. An optical detector can then collect the modulated light where the modulated scattered light is demodulated to identify the frequency of the oscillations.

Yet another advantage provided by the use of a laser, as opposed to broad spectrum lighting is the elimination of most ambient noise sources within the equipment. Broad spectrum lighting applications receive and must discriminate out vibrations from all reflecting surfaces within the equipment that surrounds the belt. Whereas, the present invention eliminates most ambient noise and detects vibrations associated solely with the belt, cable or line illuminated by the laser.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIGS. 1A, 1B, and 1C illustrate two prior art solutions;

FIG. 2 illustrates one general embodiment of the present invention;

FIG. 3 illustrates a second embodiment of the present invention that incorporates a non-board amplification module;

FIG. 4 depicts one embodiment that incorporates a feed back loop; and

FIG. 5 provides a block diagram of the present invention.

### DETAILED DESCRIPTION OF THE INVENTION

Preferred embodiments of the present invention are illustrated in the FIGUREs, like numerals being used to refer to like and corresponding parts of the various drawings.

The present invention provides a system and method with which to measure belt tension that substantially eliminates or reduces disadvantages and problems associated with previously developed systems and methods. The present invention provides a non-contact drive belt tension monitoring apparatus for measuring drive belt tension on a drive belt vibrating in response to a stimulus. A coherent light source, associated with the drive belt, generates coherent light which is reflected by a determined region of the drive as reflected coherent light. A light receiver receives reflected coherent light containing vibration information. Attached circuitry processes the output of the light receiver to generate a drive belt tension measurement.

The present invention measures the tension on a drive belt, cable, or line with a laser beam or other coherent beam of light. The laser beam strikes a resonating belt, cable or line under tension to produce scattered modulated light representative of the oscillations of the belt, cable or line. An optical or other like detector gathers the scattered modulated light to measure the frequency of the oscillations. This frequency can be used to quickly determine the tension associated with the belt, cable or line.

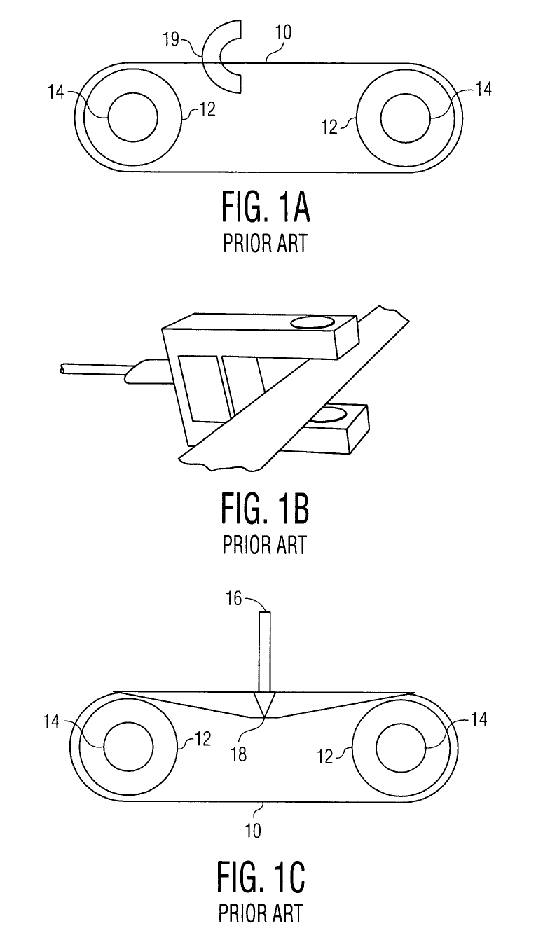

The present invention may act passively with respect to an already resonating belt. In this case the belt need not be plucked or contacted as is done by the prior art solutions associated with FIGS. 1A, 1B, and 1C. Additionally, the present invention allows measurements to be taken on extremely small belts with limited access. This limited access is often required by the design constraints of the device to which the belt is attached. The present invention only requires access to one side of the belt and is unaffected by ambient noise.

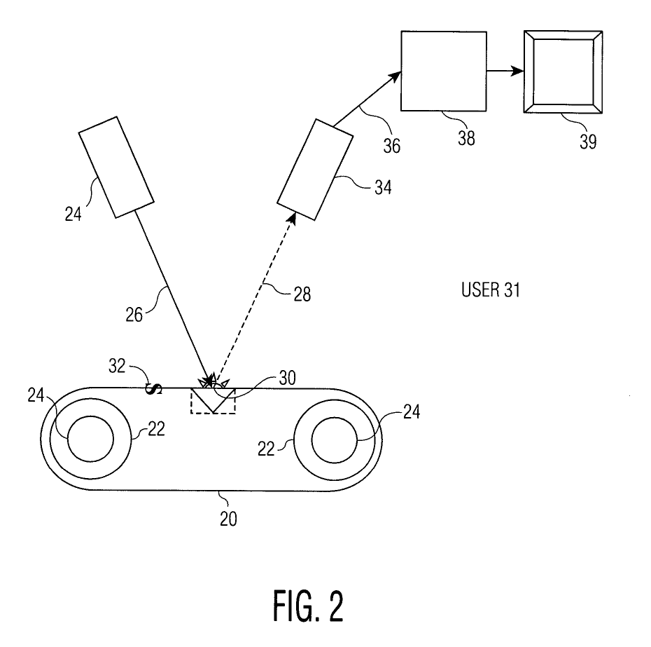

In the embodiment of the present invention illustrated in FIG. 2, a drive belt, cable or line 20 under tension is located between two end points or pulleys 22. Coherent light source 24, such as a laser, illuminates drive belt 20. The surface of drive belt scatters coherent light beam 26 to produce modulated light 28. If drive belt 20 has a dark surface, then a marker 30 may be placed on the belt for reflectivity purposes. Operator 31 may pluck the belt to start the resonance of the belt. Alternatively, an already resonating belt need not be plucked. Vibrations 32 evidence a resonating drive belt 20. Light receiver 34, such as a photo detector or photo transistor, collects modulated light 28 scattered by drive belt 20. Light receiver 34 converts the collected modulated light into output signal 36 containing information representative of vibrations 32. This signal may be in the form of an optical or electrical signal and be either digital or analog depending on the configuration of light receiver 34. Processor 38 receives output signal 36 and decodes the modulated light to produce an output for display on an output device 39 to operator 31. One such output device may be a liquid crystal display that indicates the frequency of the belt oscillations.

The present invention provides a significant advantage over prior art systems which use broad spectrum light to illuminate belt 20. Such prior systems receive light scattered by all the components proximate to the drive belt. The use of the laser allows operator 31 to very accurately measure vibrations 32 at only one location on drive belt 20. Thus the present invention can avoid most ambient noise caused by vibrations not associated with the belt.

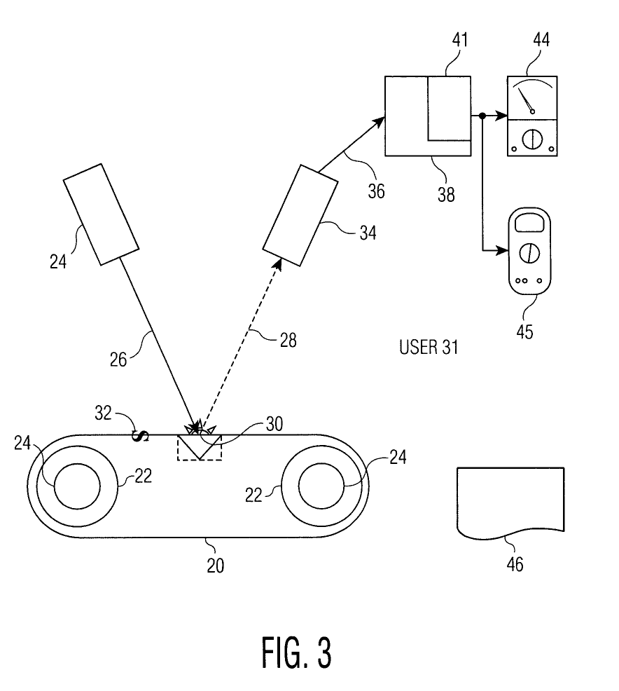

The embodiment of the present invention illustrated in FIG. 3, uses an on-board amplification module 41 coupled to light receiver 34 and processor 38 to generate a voltage representative of the frequency of vibrations 32. This allows operator 31 to merely measure the output voltage and convert that reading into a frequency valve. Operator 31 may measure this voltage with a standard analog multi-meter 44 or digital multi-meter 45 Operator 31 can quickly reference or cross-reference the measured voltage to a given frequency for vibrations 32 within drive belt 20 with table 46. This combination eliminates the need for a specialized device to further process the output signal. In one embodiment, the conversion may be simplified such that conversion table 46 correlates 0.1 volt to 100 hertz, 0.2 volts to 200 hertz, 0.3 volt to 300 hertz, etc. This allows operator 31 to easily determine the frequency of oscillation 33 without consulting conversion table 46.

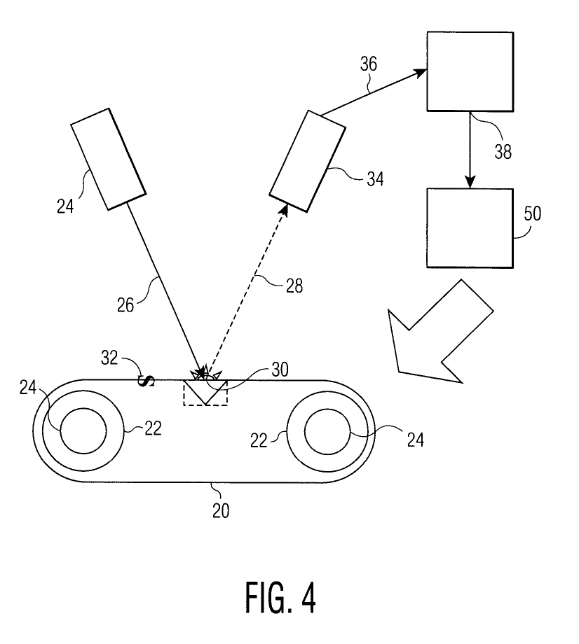

Another embodiment is illustrated in FIG. 4. The system of FIG. 4 is similar to that of FIG. 3. Here, coherent light source 24 generates coherent light beam 26 which is scattered by resonating belt 20 having vibrations 32. Vibrations 32 modulate and scatter coherent light beam 26. Light receiver 34 collects scattered modulated light 28 to produce an output signal 36. Processor 38 determines the frequency of vibrations 32 and provides this data as an input signal to feedback system 50. System 50 can adjust the tension on belt 20 to achieve a desired measured frequency of vibration 30. This may be accomplished by adjusting the endpoint or tension applied from pulleys 22 to drive belt, cable, or line 20 to change or tune measured vibration 32 to a desired frequency. It is conceivable that this may be used to maintain a pre-determined amount of stress or tension on line 20 for various purposes as is known to those skilled in the art. Alternatively, one could use this method to automatically tune musical instruments.

In another embodiment, feedback system 50 can also track the rotation of pulleys 22 and motion of drive belt 20, to identify slippage between the pulleys and drive belt. This allows errors associated with the drive belt to be guided or compensated for.

Where tension must be maintained at a constant level, such as within assembly equipment for placing electrical components on a printed circuit board, the present invention collects measurements at the beginning of each shift or repeatedly throughout the shift (even on a component by component basis). This allows process controls and statistical methods to be used to track the performance of the mounting tool and the life span of the drive belt, cable, or line 20. This enables operators and engineers to quickly identify and replace defective belts prior to a failure that causes scratch material or material that is required to be reworked.

The use of a laser within the present invention allows the operators to not only access belts that are inaccessible but to access belts from a greater distance than was previously possible. Furthermore, this non-contact method allows measurements to be taken while the belt is in operation. In such cases, as long as the belt resonates, the laser need merely be scattered by resonating drive belt 20. The system's optical detectors collect the modulated scattered light.

Additionally, the use of lasers, as opposed to a broad spectrum light, eliminates most ambient noise sources within the collected modulated light. Broad spectrum applications receive and must discriminate out vibrations from all reflecting surfaces within the assembly equipment surround belt 20. The present invention, by using a laser, only illuminates the belt and thus eliminates most ambient noise. Therefore, the present invention only detects vibrations associated with the belt, cable or line illuminated by the laser.

Additionally, a filter coupled to light receiver 34 allows frequencies not close to that of the original coherent light beam 26 to be fully filtered out. This further improves the signal to noise ratio. Light receiver 34 may be an optical Darlington pair, an optical transistor or other like device as is known to those skilled in the art. An optical transistor receives the faint scattered modulated laser light and modulates this signal onto an electrical signal that may be amplified as needed.

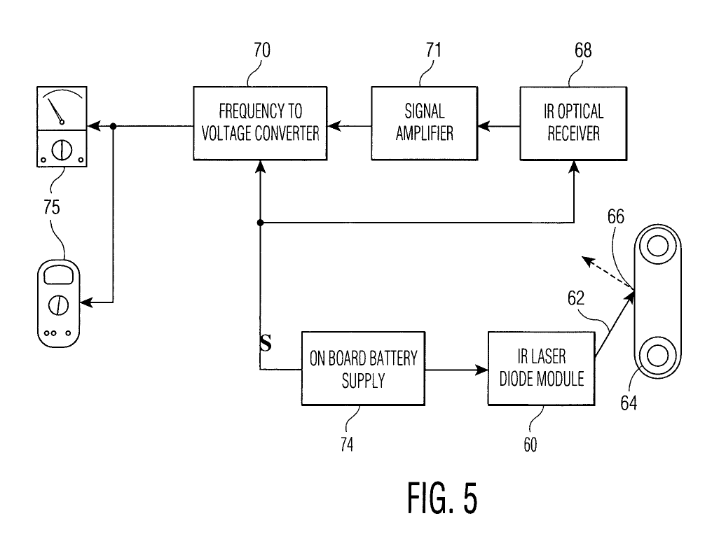

FIG. 5 provides a block diagram illustrating the processes within the present invention. Here a laser diode 60 generates a laser beam 62. Laser beam 62 is scattered by belt 64 wherein belt 64 is resonating at frequency 66. Optical receiver 68 collects the scattered modulated light. The collected optical signal is amplified and processed by signal processor 71 to produce an output signal representative of frequency. Frequency-to-voltage module 70 provides a voltage output easily read by a multi-meter 72, which then provides the operator with the frequency of the resonance of drive belt 64. An optional on-board battery supply 74 makes the device portable and not dependent on external power sources.

It should now be appreciated that the objects of the invention have been satisfied. While the invention has been described in particular detail, it should also be appreciated that numerous modifications are possible within the intended spirit and scope of the invention.

What is claimed is:

1. A non-contact drive belt tension monitoring apparatus for measuring drive belt tension, said drive belt further vibrating in response to a stimulus, said tension monitoring apparatus comprising:
a coherent light source associated with the drive belt for generating coherent light for reflection by a determined region of the drive belt as reflected coherent light;
a light receiver associated to receive said reflected coherent light, including from said reflected coherent light vibration information relating to the vibration from the stimulus; and
circuitry associated with said light receiver for generating a drive belt tension measurement from said vibration information.

2. The apparatus of claim 1, wherein said circuitry generates an output representative of said drive belt tension measurement comprising a voltage.

3. The apparatus of claim 2, wherein said voltage is measurable by a multi-meter.

4. The apparatus of claim 1, wherein said light receiver comprises an optical Darlington pair.

5. The apparatus of claim 1, wherein said light receiver comprises an optical transistor.

6. The apparatus of claim 1, wherein the drive belt is used to position printed circuit board assembly equipment.

7. The apparatus of claim 1 wherein said circuitry further comprises a frequency to voltage converter.

8. The apparatus of claim 5, wherein said optical transistor converts an optical signal to an electric signal.

9. The apparatus of claim 1, further comprising a feedback loop operable to adjust tension on the drive belt based on said drive belt tension measurement.

10. The apparatus of claim 6, wherein said printed circuit board assembly equipment places components on a printed circuit board by steering mounting equipment to a precise location by tracking belt motion.

11. The apparatus of claim 1, further comprising a means with which to cause the drive belt to vibrate.

12. An apparatus for measuring tension on a belt, comprising:
a coherent light source that generates a beam of coherent light, wherein said beam of coherent light can be directed onto a surface of the belt;
an optical detector to collect scattered coherent light, wherein said scattered coherent light is modulated by an oscillation of said surface, and wherein said optical detector generates an output representative of said oscillation; and
a processor that receives said output from said optical detector representative of said oscillation to produce an output representative of the tension on the belt.

13. The apparatus of claim 12, further comprising a computer to track belt motion relative to pulley motion and generate an alarm when said belt motions differ from said pulley motion by a predetermined amount.

14. The apparatus of claim 2, wherein said output representative of the tension on said belt comprises a voltage measurable by a multi-meter.

15. The apparatus of claim 12, wherein said optical detector comprises an optical Darlington pair.

16. The apparatus of claim 12, wherein said optical detector comprises an optical transistor.

17. The apparatus of claim 12, wherein said belt is in printed circuit board assembly equipment.

18. The apparatus of claim 12, further comprising a frequency to voltage converter.

19. The apparatus of claim 16, wherein said optical transistor converts an optical signal to an electric signal.

20. The apparatus of claim 12, further comprising a feedback loop operable to adjust the tension on the belt based on said output representative of the tension on the belt.

21. The apparatus of claim 17, wherein said assembly equipment places components on a printed circuit board by steering mounting equipment to a precise location by tracking belt motion.

22. The apparatus of claim 12, further comprising a means with which to cause the belt to oscillate.

23. A non-contact method of monitoring and measuring drive belt tension comprising the steps of:
vibrating the drive belt within stimulus;
generating a coherent light;
scattering said coherent light by the drive belt;
collecting coherent light scattered by the drive belt with a light receiver, wherein said scattered coherent light contains vibration information relating to the vibration from said stimulus; and
processing an output from said light receiver with a circuitry to generate a drive belt tension measurement from said vibration information.

24. The method of claim 23, wherein said output representative of said drive belt tension measurement comprises a voltage.

25. The method of claim 24, wherein said voltage is measurable by a multi-meter.

26. The method of claim 23, wherein said light receiver comprises an optical Darlington pair.

27. The method of claim 23, wherein said light receiver comprises an optical transistor.

28. The method of claim 23, wherein the drive belt is used to position printed circuit board assembly equipment.

29. The method of claim 24, further comprising the step of converting a voltage to a frequency.

30. The method of claim 27, wherein said optical transistor converts an optical signal to an electric signal.

31. The method of claim 23, further comprising the steps of adjusting the drive belt tension with a feedback loop based on said drive belt tension measurement.

32. The method of claim 28, further comprising the step placing components on a printed circuit board by steering mounting equipment to a precise location by tracking belt motion within assembly equipment.

33. The method of claim 28, further comprising the step of comparing drive belt motion to pulley motion and generating an error when said drive belt motion differs from said pulley motion.

34. A method of measuring tension on a belt, comprising the steps of:
generating a coherent beam of light with a coherent light source;
directing said coherent beam of light onto a surface of the belt;
collecting scattered coherent light with an optical detector, wherein said scattered coherent light is modulated by an oscillation of said surface;
generating an output representative of said oscillation with said optical detector; and
processing said output from said optical detector to produce an output representative of the tension on the belt.
